(19) United States
(12) Patent Application Publication
(10) Pub. No.: US 2017/0109717 A1
(43) Pub. Date: Apr. 20, 2017

(54) SECURE SMS / EMAIL TOKENIZATION SYSTEMS

(71) Applicant: PAYPAL, INC., San Jose, CA (US)

(72) Inventor: Con Vafeas, Sydney (AU)

(21) Appl. No.: 14/884,710

(22) Filed: Oct. 15, 2015

(51) Int. Cl. G06Q 20/10; G06Q 20/42; G06Q 20/32; G06Q 20/36; H04W 4/14; H04L 12/58

(52) U.S. Cl. CPC G06Q 20/102; H04W 4/14; H04L 51/08; G06Q 20/3255; G06Q 20/3672; G06Q 20/42; G06Q 2220/00

(57) ABSTRACT

Methods and systems for secure SMS or e-mail message tokenization are described. A user may process a transaction and/or register with a billing platform at least partly through a SMS or e-mail message. The user account information may be tokenized. Future payments from the user may be processed through tokenized SMS or e-mail messages sent by a billing management platform according to the registered user account information.

### BACKGROUND

1. Field of the Invention

The present invention generally relates to tokenized transactions, and more particularly to using short message service (SMS) or e-mail to process single or repeated transactions.

2. Related Art

Increasingly, mobile phones may be used to conduct electronic transactions. However, conventional SMS payment providers typically only offer an offline solution. Such solutions are typically not PCI compliant and require physical sales representatives to obtain credit card numbers or other payment information over the phone in an insecure manner.

### BRIEF DESCRIPTION OF THE FIGURES

FIG. 1 is a block diagram showing a transaction system according to an embodiment of the disclosure.

FIG. 2 is a block diagram showing further details of a transaction system according to an embodiment of the disclosure.

FIG. 3 is a flowchart showing SMS or e-mail payment according to an embodiment of the disclosure.

FIG. 4 is a flowchart showing risk analysis according to an embodiment of the disclosure.

FIG. 5 shows a user interface according to an embodiment of the disclosure.

FIG. 6 shows a further user interface according to an embodiment of the disclosure.

FIG. 7 shows another user interface according to an embodiment of the disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that facilitate transactions using SMS and/or e-mail. The present disclosure describes some embodiments of a transaction system that may include a billing management platform and a customer device and allow transactions to be performed over SMS and/or e-mail. The transaction may also involve other components such as customer relationship management databases, message gateways, and other devices. The customer may register transactional information with the billing management platform. The transactional information may be tokenized, stored, and used to process future user transactions. Additionally, transaction history may also be stored and future transactions may be accessed for risk.

The advent of the internet has allowed mobile phones or other mobile devices (e.g., tablets, laptops, personal data assistants, and/or wearable electronic devices) to be used as payment devices. However, such payments are generally online payments that are processed through either a web browser or an app installed on the mobile device. In certain instances, the mobile device may be disconnected from the internet, though there may be SMS reception, or the user may not wish to install an app. Such instances may prevent the transaction from being processed. The present invention may allow the processing of the transaction through SMS or e-mail, resulting in advantages including saving hard drive or memory space on a mobile phone since no app needs to be installed, allowing for the processing of the transaction while the phone is not connected, and allowing multiple phone numbers to be associated with a user and allowing the transaction to be processed from each of those phone numbers. Additionally, SMS payments may offer a quicker and more convenient solution for payment.

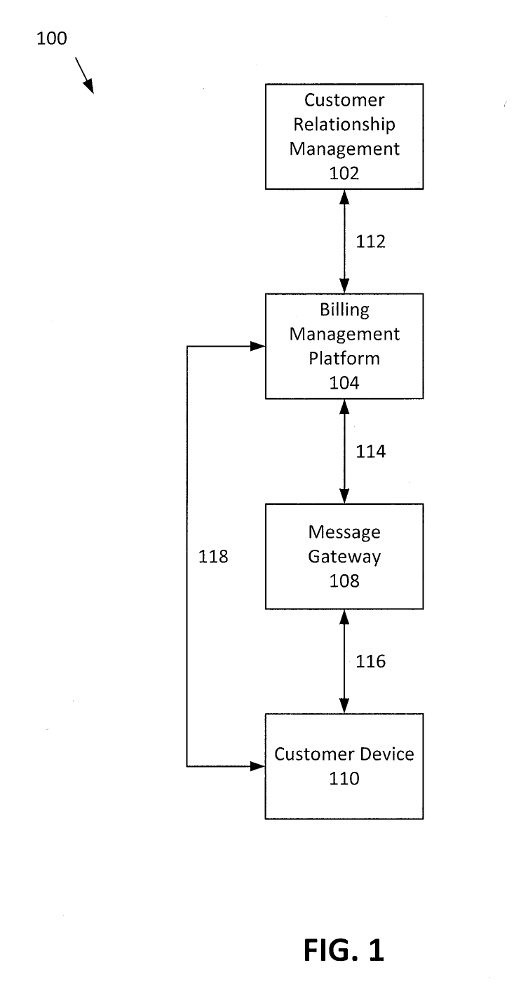

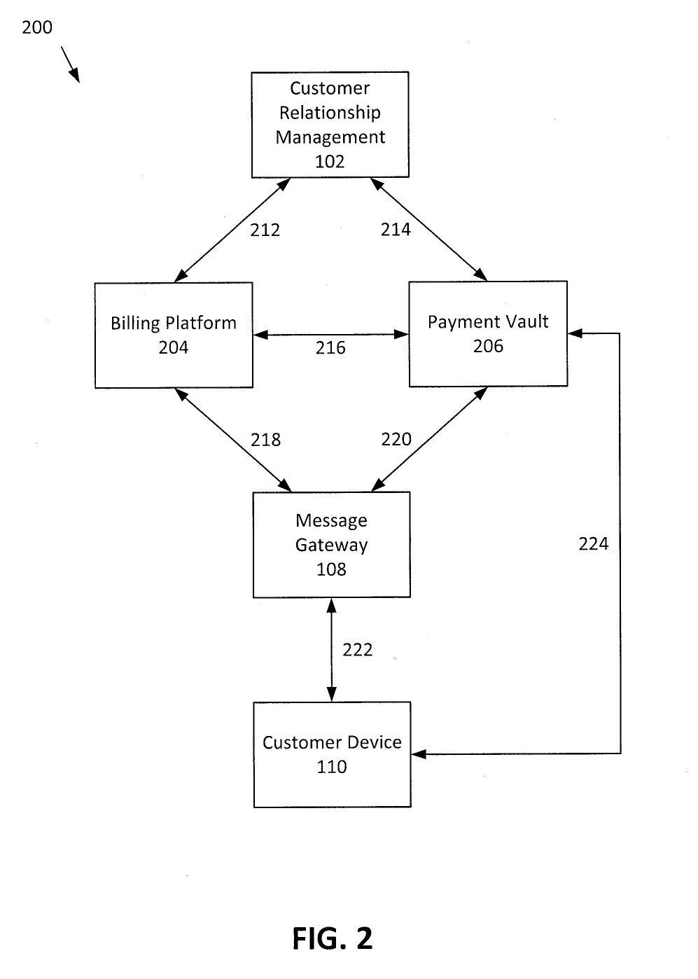

The present invention may be performed with certain payment systems. FIG. 1 is a block diagram showing a transaction system according to an embodiment of the disclosure. While FIGS. 1 and 2 describe certain components and system to perform the techniques described herein, it is appreciated that other embodiments may include additional components, may include fewer components, or may include other components.

FIG. 1 shows a transaction system 100 that includes customer relationship management (CRM) database 102, a billing management platform 104, a message gateway 108, and a customer device 110. The CRM 102 may be connected to the billing management platform 104 via a communications path 112. The billing management platform 104 may be connected to the message gateway 108 via a communications path 114. The message gateway 108 may be in communication with the customer device 110 via a communications path 116. Additionally, the customer device 110 may be in communication with the billing management platform 104 via a communications path 118. In certain other embodiments, other components of the transaction system may include addition communications paths allowing other devices to be in communication with each other, such as allowing the CRM 102 to communicate with the customer device 110. Additionally, other embodiments may have fewer communications paths and certain devices may receive communication from one device and transfer it to another.

A user may have, use, or operate the customer device 110. The customer device 110 may be, for example, a smartphone, a personal data assistant, a tablet, a wearable electronic device (such as a smartwatch or electronically augmented glasses), a laptop, or other electronic device. The customer device 110 may include a user interface that includes a combination of one or more of a display screen, a data entry device such as a keypad or touch screen, buttons, facial or movement recognition abilities, or other items allowing a user to interface with the customer device 110. The user may use the customer device 102 to conduct a transaction.

The message gateway 108 may be, for example, a SMS gateway that allows for receiving and delivering SMS (text) messages, an e-mail server that allows for sending and receiving e-mail messages, or the sending and receiving of communications through another technique. In certain embodiments, the message gateway 108 may receive information from the customer device, convert the information into another format suitable for transmission to the billing management platform 104, and transmit the converted information to the billing management platform. The message gateway 108 may also receive, convert, and transmit the converted information in the opposite direction (e.g., from the billing management platform 104 to the customer device 110). The message gateway 108 may be connected to the customer device 110 via the communications link 116. The communications link 116 may be a SMS link, a data connection (e.g., an internet connection such as 3G, 4G, Edge, WiFi, Bluetooth, Near Field Communications, and other data connections), or another link where information may be transferred between devices.

The billing management platform 104 may be a server or a collection of servers and/or other devices that may store user and/or transaction details, process user payments, manage tokens, and generate messages to the user. Such data may be, for example, account identifiers or account numbers, user information such as name, contact information (e.g., phone numbers, e-mails, social media accounts, messaging service accounts, or other contact information), contact preferences, account information (e.g., bank account information, balance information, credit card numbers, expiration dates, or PIN numbers), account balance, information on the location of the user (such as where the user has been), and other information associated with the account holder. The billing management platform 104 may process transactions of the user by, for example, confirming payment associated with the transaction and transferring funds from the user's account to that of the merchant's account.

The billing management platform 104 may be located on a single device (such as a single server or point of sale terminal), multiple devices at roughly the single location (such as a single server farm that includes multiple servers), or over multiple locations (e.g., located at multiple locations connected by a network such as the internet “cloud). The billing management platform may include one or more non-transitory memories (e.g., one or more magnetic or optical hard drives or solid state drives), and one or more processors communicatively coupled to the non-transitory memory(s). The non-transitory memory may store instructions for operations that may be communicated to the one or more processors for the one or more processors to perform.

In other embodiments, the billing management platform 104 may be, for example, part of a point of sale terminal or point of transaction. The point of sale terminal or point of transaction may be a kiosk, an automated teller machine, a checkout machine, a mobile device, a scanner, or another device that allows a user or customer to purchase, check out, and/or pay for items. The merchant may be a physical store, an electronic commerce merchant, a mail order and/or telephone merchant, an individual, a pending machine, kiosk, or other unattended device, or another individual or entity that offers products or services for sale.

As shown in FIG. 1, the billing management platform 104 may additionally be in communication with the customer device 110 via the communications link 118. The communications link 118 may be, for example, a connection over the internet between the billing management platform 104 and the customer device 110. The communications link 118 may be a connection over one or more payment networks.

The CRM 102 may be a system that may process transactions. The CRM 102 may perform one or more of the following functions: initiate transactions, process transactions as well as update a status of the transaction, store and/or communicate tokens, and store transaction information associated with the user. The CRM 102 may, in certain embodiments, be separate from the billing management platform 104, but in other embodiments, the CRM 102 may be integrated with the billing management platform 104 (e.g., the non-transitory memory and the processor of the billing management platform 104 may include instructions and perform functions described for the CRM 102). In embodiments where the CRM 102 is separate from the billing management platform 104, the CRM 102 may be in communication with the billing management platform 104 via the communications link 112. The communications link 112 may be any connections link that may transfer data between the CRM 102 and the billing management platform 104.

In some embodiments, the communication between the various components of the system 100 may be direct or indirect communication. Direct communication may be communication where components are directly in contact with each other. Indirect communication may be communication where the merchant 108 is in communication with one or more servers of the transaction management system 130 via one or more intermediaries such as merchant processors or gateway providers.

In an illustrative example, a user operating the customer device 110 may approach a merchant with a point of sale device to conduct a transaction. The user may interact with the merchant to confirm the transaction. The merchant may then initiate the transaction with the point of sale device by, for example, inputting the phone number of the customer device 110 into the point of sale device, through the scanning of a code shown by the customer device 110 with a scanner, through the scanning of a code by the merchant with the customer device 110, or through a contactless communication between a point of sale and the customer device 110. The customer device 110 may be a mobile device having an RFID chip installed therein allowing the device to be operated pursuant to ISO/IEC 18092, NFC IP-1 or the ISO/IEC 14443 contactless communication standards, or other applicable contactless communication standards and wireless technologies including but not limited to those for Bluetooth and Bluetooth Low Energy (BLE) and NFC. In some embodiments, the merchant may additionally scan or additionally process the transaction with a single or multiple device, such as a desktop payment terminal, a mobile point of sale device including devices that enable magnetic stripe and EMV (Eurocard, Mastercard, and Visa) translations to be performed such as devices from companies like PayPal, Square, and others, or a mobile device for person to person transactions, or the like. The point of sale device may then communicate the intention to initiate the transaction to the CRM 102. The CRM 102 may be associated with a SMS/e-mail payment service described herein.

Once the CRM 102 receives the transaction initiation, the CRM 102 may communicate the transaction details (e.g., the items purchased, total of the transaction, time of transaction, and/or merchant and user information) to the billing management platform 104 via the communications link 112. The billing management platform 104 may then receive the transaction details and determine if there is an outstanding token associated with the transaction and/or the customer or user. If there is no outstanding token, the billing management platform 104 may generate a token for the transaction. Additionally, if there is no outstanding token, the billing management platform 104 may check to see if the user is an existing registered user of a billing platform associated with the billing management platform 104 (e.g., a registered PayPal®, BitCoin®, Apple Pay®, or user of a credit card using the SMS/e-mail payment service).

If the user is not a registered user, the billing management platform 104 may send a message to the message gateway 108 via the communications link 114. The message may include a link or other technique to allow the user to register with the billing platform. The link may direct the user to a webpage that allows the user to input details (such as name, address, billing information, credit card or payment account information, phone number, e-mail, and other contact information, and other user information). Other embodiments may allow users to reply with such information directly via SMS and/or e-mail, or allow users to input information through a third party program (such as an app or the user pointing to information associated with the third party).

Once the user has inputted his or her information into the customer device 110, the information may be sent to the billing management platform 104 through a data connection or the customer device 110 may send the information through the message gateway 108 (e.g., via SMS) and the message gateway 108 may then communicate the information to the billing management platform 104. The information may be stored or communicated by the billing platform for future use. In certain embodiments, the information may be stored within a secure PCI compliant vault.

After the information has been communicated to the billing management platform 104, the information may then be further communicated to the CRM 102 via the communications link 112. The CRM 102 may then create a record of the transaction (e.g., by issuing or storing a token). In certain other embodiments, the information may not be communicated from the billing management platform 104 to the CRM 102. In such embodiments, the billing management platform 104 may process the transaction without the CRM 102 and may, thus, create a record or token associated with the transaction. After the record or token has been created, the transaction may be processed by the billing management platform 104. The billing management platform 104 may charge the customer, process payment through the customer's credit card, bank account, mobile wallet, or other payment account, and send a confirmation SMS to the message gateway 108 for communication to the customer device 110 or directly send a confirmation of the transaction to the customer device 110.

If the user is a registered user, the user may input, into the customer device 110, a reply to the SMS received from the message gateway 108 confirming the transaction. The reply may be sent via SMS (sent to the message gateway 108 that may then send the confirmation to the billing management platform 104), through e-mail, through information inputted into a website, or through other techniques. Once the billing management platform 104 has received the confirmation, it may then look up the transaction via a transaction number and/or token and process the transaction by charging the customer, processing payment through the customer's credit card, bank account, mobile wallet, or other payment account, and sending a confirmation SMS to the message gateway 108 for communication to the customer device 110 or directly sending a confirmation of the transaction to the customer device 110.

In certain embodiments, the transaction system may be further divided into separate systems. FIG. 2 may show such an embodiment. FIG. 2 is a block diagram showing further details of a transaction system according to an embodiment of the disclosure. The transaction system 200 of FIG. 2 may be similar to the transaction system 100 of FIG. 1. However, in the transaction system 200, the billing management platform 104 of the transaction system 100 may be further divided into a billing platform 204 and a payment vault 206. The billing platform 204 and the payment vault may be in communication via a communications link 216 and both the billing platform 204 and the payment vault 206 may be in communication with the CRM 102 via communications links 212 and 214, respectively, and may be in communication with the message gateway 108 via communications links 218 and 220, respectively. In FIG. 2, the customer device may be in communication with the payment vault 206 via the communications link 224, though other embodiments may also have the customer device 110 be in communications with the billing platform 204.

The billing platform 204 may, in certain embodiments, create and/or process tokens associated with the transaction. Accordingly, the billing platform 204 may, upon receiving an indication from the CRM 102 that a transaction has been initiated, check for or create a token associated with the transaction. The billing platform 204 may also process the transaction by, for example, receiving a confirmation SMS from the message gateway 108 sent by the customer device 110 to the message gateway 108. The billing platform 204 may then aid in the processing of the transaction by charging the token. After the transaction has been processed, the billing platform 204 may then generate and send a transaction confirmation.

The payment vault 206 may also aid in the processing of the transaction by processing payment (e.g., by transferring of funds from a user account to the merchant or by communicating with a user account such as a user credit card or bank account to transfer funds to the merchant) in response to the billing platform 204 processing the token. The payment vault 206 may also provide indication of a successful transaction to the billing platform 206 (responsive to which the billing platform 206 may generate the transaction confirmation). Additionally, the payment vault 206 may store user account information, such as credit card number and information (e.g., expiration, PIN, and/or security code), bank account number and information (e.g., PIN, routing number, and/or SWIFT code), payment account information (e.g., information associated with a PayPal®, Apple Pay®, or other payment account), personal user information (e.g., name and/or date of birth), billing address, contact information (e.g., phone number, social media account information, and/or e-mail address), and/or other information within a Payment Card Industry (PCI) standards compliant vault. In certain examples, the customer device 110 may transmit such information to the payment vault 206, either directly or indirectly (e.g., by sending a SMS message to the message gateway 108 that may then send the SMS message to the payment vault 206).

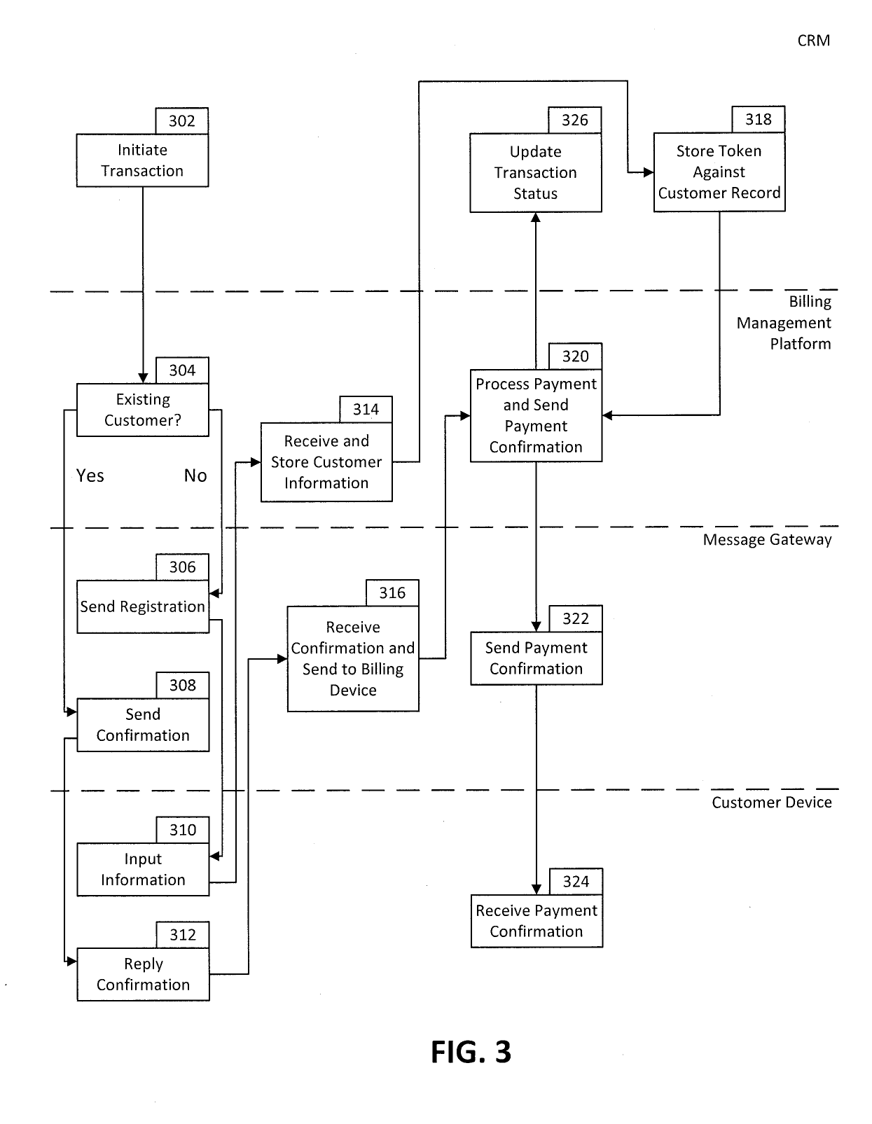

The systems of FIGS. 1 and 2 may be used for tokenized SMS or e-mail payments. FIG. 3 is a flowchart showing SMS or e-mail payment according to an embodiment of the disclosure. FIG. 3 is divided into processes performed by the CRM, the billing management platform, the message gateway, and the customer device. The CRM may be, for example, CRM 102 of FIGS. 1 and 2. The billing management platform may be the billing management platform 104 of FIG. 1.

In certain embodiments, the steps performed by the billing management platform may be performed by either or both of the billing platform 204 and the payment vault 206 of FIG. 2. The message gateway may be the message gateway 108 of FIGS. 1 and 2 and may allow the transmission of messages (e.g., SMS message) between the billing management platform and/or CRM and the customer device. The customer device may be the customer device 110 of FIGS. 1 and 2. It is appreciated that various embodiments may perform certain processes with a different component than that described herein. Thus, for example, a process described as being performed by the customer device may be performed, in certain embodiments, by the transaction device and/or the cloud device.

In block 302, the transaction may be initiated. The CRM may initiate the transaction responsive to an indication from a point of sale device, the customer device, from check out on a website, or from another source providing an indication of transaction initiation. In certain embodiments, upon initiation the transaction, the CRM may create a record and/or token associated with the transaction. The CRM may then communicate, to the billing management platform, that the transaction has been initiated. In embodiments where the CRM has created a token, the CRM may communicate the token to the billing management platform.

After the transaction has been initiated, the billing management platform may then check to see if the customer is an existing customer or registered user in block 304. The billing management platform may determine whether the customer is an existing customer or registered user by seeing if there is an account associated with the customer or user by, for example, seeing if there is a match between the phone number (or other information provided) of the user with any accounts associated with any billing platforms. In certain embodiments, the billing management platform may be able to consult user data related to only one billing platform, but other embodiments may allow the billing management platform to look up user data of multiple billing platforms to determine if the customer or user is an existing customer or registered user. The customer or user information may be stored in, for example, a PCI compliant vault or on storage components (e.g., a hard drive or solid state drive) of a computer or server system. In certain such embodiments, the server system may be distributed over multiple devices or over multiple locations (e.g., over the cloud). In certain embodiments, the billing management platform may, when it is unable to match the user information with an account, send the customer device a message, directly or indirectly, asking if the user wishes to update information associated with an existing user account. The customer or user may then, upon receiving such a message, update his or her account with updated information. In other embodiments, the customer may be offered the opportunity to update her or her account information at any point during a transaction, either via SMS or via through communications method.

If it is determined in block 304 that customer or user is not an existing customer or registered user, the process may proceed to block 306 and send a registration to the customer device to be filled out by the customer or user. The registration may be, for example, a link to an onboarding website that allows potential customers to register with the billing platform, a template for reply (via SMS, e-mail, or other communication method) from the user with information for registering with the billing platform, or a link to a website that allows the user to associate his account information with information from another source (e.g., allow the billing platform the user is registering for to import information related to the user from, for example, the user's bank). The user may then input information required by the billing platform for establishing an account with the customer device (e.g., through a user interface of the customer device) in block 310.

The information may be sent to the billing management platform, either directly or indirectly (via the message gateway) and received by the billing management platform in block 314. Upon receiving the customer or user information, the billing management platform may store the information. The billing management platform may store the customer or user information in, for example, a PCI complaint vault. The payment vault 206 of FIG. 2 may be such a PCI compliant vault and, in certain embodiments, the billing management platform may tokenize the customer or user information before storing the information.

In certain embodiments, once a customer or user has registered with the billing platform, a token associated with the customer or user may be created. Various embodiments may create the token with the billing management platform or the CRM. In block 318, the embodiment described in FIG. 3 may create a token with the CRM. The CRM may then, in block 318, store the token and associate it with the customer record or information provided by the user. The token may be used for a transaction or multiple transactions by the customer or user.

In block 320, the billing management platform may then process the payment and send a payment confirmation to the customer device. The payment may be processed by charging the customer account, credit card, bank account, or other associated account and transferring payment from such accounts to the merchant.

Referring back to block 304, if the billing management platform determines that the user is an existing customer in block 304, the process may then proceed to block 308. In block 308, a message confirming the transaction may be generated by the billing management platform and communicated to the message gateway for sending to the customer. The confirmation message may be a message that merely informs the user of the customer device of the transaction, or it may be a message that may allow the user of the customer device to reply with a confirmation authorizing the transaction and allow the transaction to proceed upon receipt of the user reply.

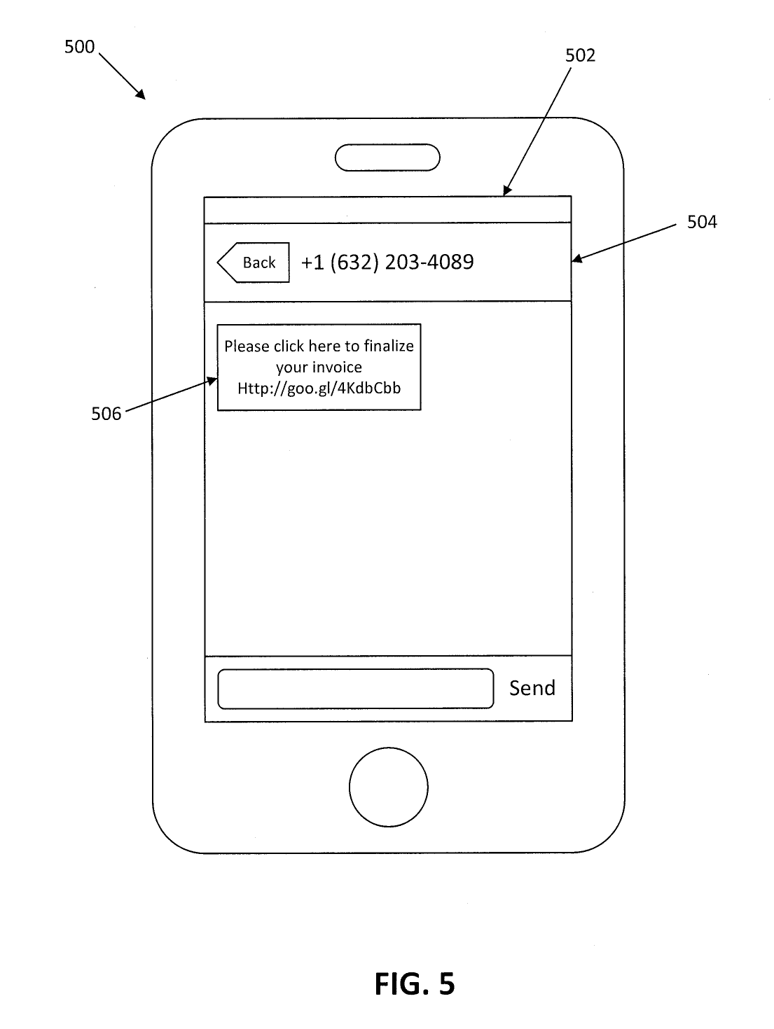

In embodiments where the message requires a user reply, the user may reply by, for example, replying to the message sent (e.g., with a SMS reply stating whether the user confirms the transaction or denies the transaction), by following a link to a webpage that allows the user to confirm the transaction, or by interfacing a link embedded into the message to confirm the transaction. Further examples of such confirmations are described in FIGS. 5, 6, and 7.

In other examples, such as recurring payments, the billing management platform may automatically process transactions. The billing platform may be, for example, a service that includes a periodic charge such as a monthly or bi-monthly charge, and the user may register with the billing platform and allow the billing platform to conduct automatic periodic payments. The billing platform may then automatically bill the customer or user when payment is due. In certain embodiments, the billing platform may automatically process the periodic payment on the due date (or another processing date specified by the customer or user) and generate a confirmation message for sending to the customer device. In other embodiments, the billing platform may send a payment confirmation to the customer device on the due date or a date specified. The customer or user may then confirm the payment via the customer device and the customer device may communicate the confirmation to the billing management platform. Upon receiving the confirmation from the customer device, the billing management platform may then process the transaction.

The confirmation message may be sent from the customer device to the message gateway in block 316. The message gateway may then send the message to the billing management platform. In certain embodiments, the message gateway may convert the message received from the customer device (e.g., SMS message) into another format suitable for communication to the billing management platform. Once the billing management platform has received the confirmation in block 320, the payment may be processed and a confirmation message generated, as described herein.

After the payment has been processed and the confirmation message generated, the transaction status may then be updated in block 326 and the payment confirmation sent in block 322. The CRM may include records that may track the status of transactions of users. For example, the CRM may assign the status of “pending” to a pending transaction. After the transaction has been processed, the transaction status may be updated to “processed,” “paid,” or another status indicator denoting that the transaction has been processed.

In block 322, the message gateway may receive the payment confirmation and transmit the confirmation to the customer device. The customer device may then receive the payment confirmation in block 324. The customer device may then communicate the payment confirmation to the user (e.g., via a user interface by displaying or audibly communicating to the user of the customer device the payment confirmation).

In an illustrative example, Izabella wants to purchase a robot. The merchant offering the robot may be affiliated with a billing platform that allows for tokenized SMS payments. Izabella uses her phone to scan a barcode affixed to the robot to start the payment process for the robot. Upon scanning the barcode, the payment app on Izabella's recognizes the robot and asks Izabella if she wishes to pay for the robot through a SMS payment. Izabella confirms, through a user interface on her phone, that she wishes to pay for the robot through SMS payment. The phone then automatically sends a message to a billing management platform of the billing platform with the phone number of the phone. The billing management platform, upon receiving the phone number, initiates a transaction and attempts to match the phone number to an existing account. However, the billing management platform is unable to find a match as Izabella's phone number and accordingly sends Izabella's phone a SMS asking if Izabella has an existing account with the billing platform or if Izabella wishes to register for a new account.

Izabella confirms that she wishes to register for a new account and so the billing platform sends Izabella a follow-on SMS with a link to a website to register for the billing platform. Izabella clicks on the link embedded within the SMS message and her phone then loads the website. The website prompts Izabella to input her name, billing address, and credit card information, which Izabella does. After Izabella confirms the information, the website sends the information to the billing management platform.

The billing management platform, upon receiving the information, the billing management platform stores Izabella's account information within a PCI compliant vault and creates a token associated with Izabella's account information. The token is communicated to a CRM and the CRM stores the token. The billing management platform then processes Izabella's robot purchase by charging the token or the account that the token stores information of. After the transaction has been processed, the billing management platform then generates a confirmation message and communicates the confirmation message from the billing management platform to the gateway for sending to the customer device.

A month later, Izabella has signed up for the monthly maintenance program for her robot and selected the option for the billing platform to process the monthly charge for the robot maintenance program. On the day the payment is due, the billing management platform sends a message to the gateway, that the gateway then converts to a SMS message that is sent to Izabella's phone. The SMS message informs Izabella that the payment is due and to reply with her authorization in order to process the payment. Izabella replies with a SMS message confirming her authorization. After receiving the authorization, the billing management platform then processes the payment.

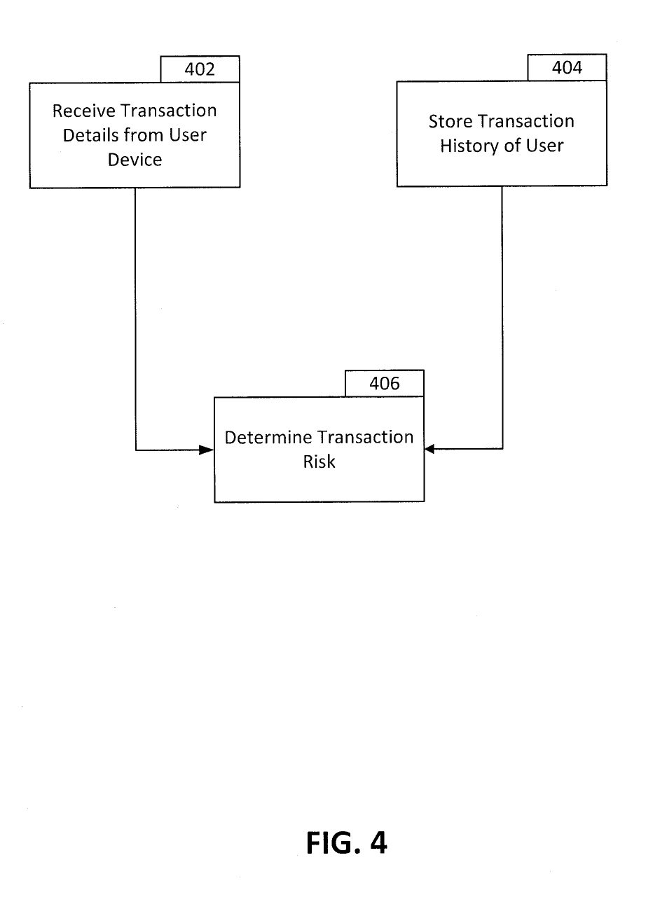

In certain embodiments, the billing management platform and/or CRM may analyze risk of a pending transaction. FIG. 4 is a flowchart showing risk analysis according to an embodiment of the disclosure. In block 404, the transaction history of a user may be stored. The transaction history may be stored in a billing management platform, a CRM, or another device that may store the transaction history. In block 402, the transaction details of a current user transaction may be received. The transaction details may be received via SMS, e-mail, or another data connection from the user device. For example, the transaction details may be received from the customer device via SMS message, a transaction website, or the billing management platform. In such an embodiment, the billing management platform may send the transaction information after the billing management platform has received a transaction confirmation from the customer device.

In block 406, a transaction risk may be determined from the transaction history and transaction details. The transaction risk may be determined by, for example, the billing management platform. The transaction risk may compare a user's transaction history with the current transaction details. One or more of the items purchased, the location of the transaction, the transaction purchase amount, the category of items purchased, the time of purchase, and/or the differences between a previous transaction in terms of items, price, and location may be compared. A risk rating may then be assigned to the current transaction in light of the transaction history of the user. If the risk rating exceeds a certain threshold, the user may be notified of a potentially fraudulent transaction. For example, the billing management platform may transmit a SMS or e-mail message to the customer device informing the user that a potentially fraudulent transaction has been detected. The message may then ask the user to confirm the transaction. The user may confirm the transaction through any of the techniques described herein, such as by replying with a confirmation SMS.

The customer device described herein may include a user interface that allows a user to initiate or perform certain steps within the transaction. FIG. 5 shows a user interface according to an embodiment of the disclosure. FIG. 5 shows a customer device 500 with a user interface 502. The user interface 502 may show a title 504 and a transaction message 506. The title 504 may include information related to the merchant (such as the name or phone number of the merchant) as well as an option to cancel the transaction or scroll back to another page. The transaction message 506 may be a SMS message that allows the user to click a link to confirm the transaction. After the user clicks the link, the customer device may load a webpage that may allow the user to confirm the transaction.

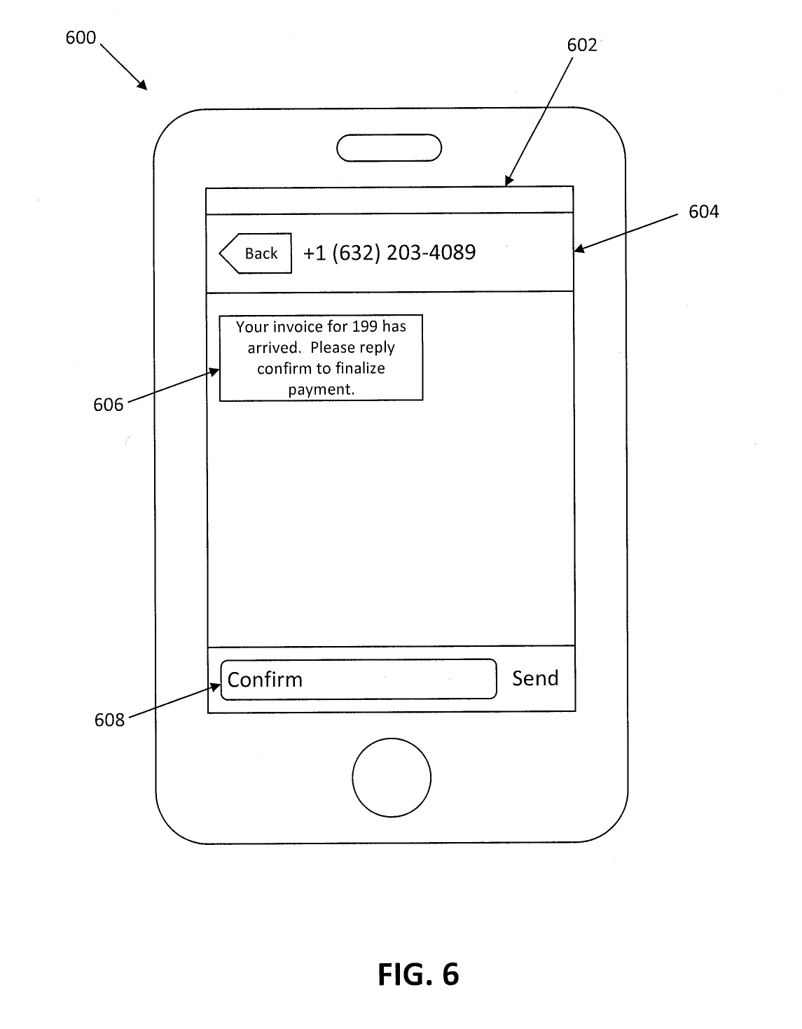

FIG. 6 shows a further user interface according to an embodiment of the disclosure. The customer device 600 of FIG. 6 may include a user interface 602. The user interface 602 may display a title 604, similar to the title 504 of FIG. 5, a message 606, and a textbox 608. The message 606 may prompt the user to reply with a SMS to confirm the transaction. The user may, accordingly, type a message (such as the message “Confirm”) into the textbox 608 to confirm the transaction.

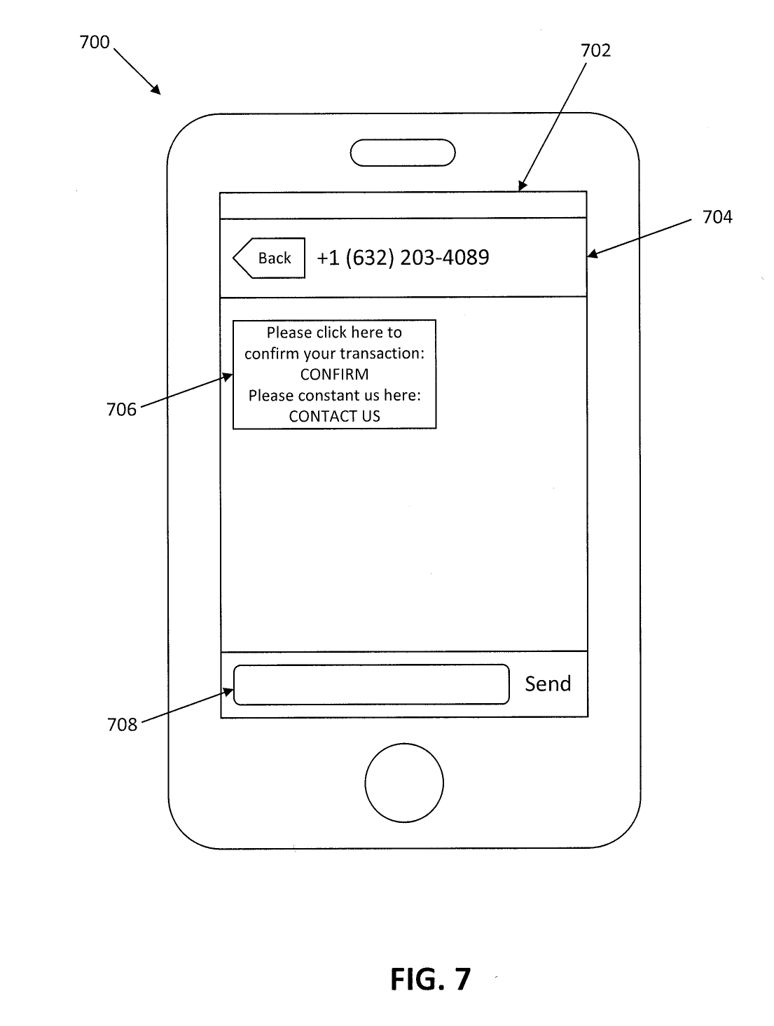

FIG. 7 shows another user interface according to an embodiment of the disclosure. The customer device 700 of FIG. 7 may include a user interface 702. The user interface 702 may display a title 704, similar to the titles 504 and 604 of FIGS. 5 and 6, and a message 706. The message 706 may include two links. A first link may allow the user to confirm the transaction while a second link may allow the user to contact the billing platform (e.g., if a transaction is fraudulent). The links may be embedded within the SMS message and, thus, the user of the customer device 700 may simply click on the link to either confirm the transaction or contact the billing platform.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A transaction processing system, comprising:
one or more non-transitory memories configured to store instructions; and
one or more hardware processors coupled to the non-transitory memories, communicatively connected to a message gateway, and configured to read instructions from the non-transitory memory to cause the system to perform operations comprising:
receive a transaction initiation indication;
generate an initial billing transmittal message;
communicate the initial billing transmittal message to the message gateway;
receive, from the message gateway and in response to the initial billing transmittal message received by a user device via an e-mail and/or a short message service from the message gateway, an initial billing response message generated by the user device and comprising user billing information;
process a payment based on the user billing information; and
store or communicate the user billing information.

2. The system of claim 1, wherein the one or more hardware processors is further configured to process a repeat billing with the user billing information via e-mail and/or short message service.

3. The system of claim 2, wherein processing the repeat billing comprises:
generating a repeat billing transmittal message and communicating the repeat billing transmittal message to the message gateway for communication to the user device, wherein the initial billing transmittal message is configured to be communicated from the message gateway to the user device via the e-mail and/or the short message service;
receiving a repeat billing response message from the message gateway, wherein the repeat billing response message is generated by the user device responsive to the repeat billing transmittal message, includes a user billing selection, and is communicated from the user device to the message gateway via e-mail and/or short message service; and
processing the repeat billing responsive to the user billing selection.

4. The system of claim 2, wherein processing the repeat billing comprises automatically processing the repeat billing.

5. The system of claim 1, wherein the user billing information comprises information associated with a credit card, a mobile wallet, an online payment service, and/or a peer to peer payment system.

6. The system of claim 1, wherein the user billing information is associated with a phone number of the user device.

7. The system of claim 1, wherein processing the payment comprises charging a token associated with a user.

8. The system of claim 1, wherein the one or more hardware processors is configured to communicate the user billing information to a customer relations management system.

9. The system of claim 1, wherein the user billing information is stored in a PCI compliant vault.

10. The system of claim 1, wherein the one or more non-transitory memories is further configured to store the user billing information.

11. The system of claim 10, wherein:
the one or more hardware processors is further configured to receive a user information update from the message gateway, wherein the user information update is generated by the user device and is communicated from the user device to the message gateway; and
update the stored user billing information stored within the one or more non-transitory memory responsive to the user information update.

12. The system of claim 10, wherein the one or more non-transitory memories is further configured to store the user billing information in a PCI compliant vault.

13. The system of claim 1, wherein the transaction initiation indication is received from a user device and/or merchant device.

14. The system of claim 1, wherein the one or more hardware processors is further configured to:
generate a transaction confirmation message; and
communicate the transaction confirmation message to the message gateway, wherein the transaction confirmation message is configured to be communicated from the message gateway to the user device via e-mail and/or short message service.

15. The system of claim 1, wherein the one or more non-transitory memories is further configured to store a transaction history associated with the user and the one or more hardware processors is further configured to determine a risk for a payment transaction associated with the payment responsive to the transaction history.

16. A user device for processing transactions conducted at least partially over an e-mail and/or short message service network comprising:
a communications component configured to communicate with a message gateway via e-mail and/or short message service;
a user interface configured to display data to a user and receive inputs from the user; and
one or more hardware processors communicatively connected to the communications component and the user interface and configured to:
receive, from the message gateway, a repeat billing transmittal message generated by a billing management platform, communicated from the billing management platform to the message gateway, and communicated by the message gateway to the user device via an e-mail and/or short message system, wherein the repeat billing transmittal message is associated with a transaction processed with saved billing information, the saved billing information is associated with user billing information communicated to a transaction processing system via the e-mail and/or the short message service, and the saved billing information is stored by the transaction processing system;
display the repeat billing transmittal message on the user interface;
receive a user input responsive to the repeat billing transmittal message;
generate a repeat billing response message responsive to the user input; and
transmit the repeat billing response message to the message gateway via the e-mail and/or the short message service.

17. The user device of claim 16, wherein the one or more processors is further configured to receive a repeat billing processed message and display the repeat billing processed message on the user interface.

18. The user device of claim 16, wherein the one or more processors is further configured to:
receive, from the message gateway, an initial billing transmittal message generated by the billing management platform communicated from the billing management platform to the message gateway and communicated by the message gateway to the user device via an e-mail and/or a short message system;
display the initial billing transmittal message on the user interface;
receive a user input responsive to the initial billing transmittal message;
generate an initial billing response message responsive to the user input; and
transmit the initial billing response message to the message gateway via the e-mail and/or the short message service.

19. The user device of claim 18, wherein the initial billing response message comprises the user billing information.

20. The user device of claim 18, wherein the user input responsive to the initial billing transmittal message is an input approving a transaction and the one or more processors is further configured to:
display, responsive to the user input, a user billing entry form; and
receive user input responsive to the user billing entry form, wherein the initial billing response message includes data associated with the user input responsive to the user billing entry form.
